(19) United States
(12) Patent Application Publication
(10) Pub. No.: US 2019/0026679 A1
(43) Pub. Date: Jan. 24, 2019

(54) METHOD FOR PERIODICAL COLLECTION OF INFORMATION IN A NETWORK OF COMPUTER STATIONS BY A COMPUTER SERVER OF SAID NETWORK

(71) Applicant: ATOS SE, BEZONS (FR)

(72) Inventors: Cyril PERNOT, CONFLANS SAINTE HONORINE (FR); François LE ROUZIC, ERMONT (FR); Jordane REYNET, ORLEANS (FR); Cyril DURIEZ, WATTRELOS (FR)

(73) Assignee: ATOS SE, Bezons (FR)

(21) Appl. No.: 16/070,739

(22) PCT Filed: Jan. 18, 2017
(86) PCT No.: PCT/FR2017/050103

§ 371 Date: Jul. 17, 2018

(30) Foreign Application Priority Data
Jan. 18, 2016 (FR) 1650387

(51) Int. Cl. G06Q 10/06; G06Q 10/10

(52) U.S. Cl. CPC G06Q 10/06398; H04L 63/083; G06Q 10/105

(57) ABSTRACT

Disclosed is a method for the periodical collection of information in a network of computer stations by a computer server of the network, the method including, on the man-machine interface of each network station, by way of an application of the station: an automatic display of an interactive window, which requests the user of the station to enter information, to validate the response of the user on their station, and to send it to the server.

### FIELD OF THE INVENTION

The invention relates to a method for periodic information collection on a network of computer stations by a computer server on this network.

### CONTEXT OF THE INVENTION

In the methods from the prior art for periodic information collection on a network of computer stations by a computer server on this network, there are several delicate compromises which are only imperfectly met.

First, the method must make a first compromise between the completeness of the data collected and the effort required both by the users providing the data collected on the workstation and by the system centralizing data collection the server. This first compromise is particularly difficult to make, when the collection is periodic, meaning when it must be done routinely.

Second, the process must make a second compromise between the flexibility of data collection making their collection from users easier and the security of the data collected preventing malicious users from diverting the mechanisms provided for collecting data from their initial purpose, so as to reduce as much as possible or even eliminate all sorts of fraud or deceit by malicious users.

In particular, in some prior art, the methods for periodic information collection on a network of computers stations by a computer server on this network propose a system asking users to connect to an application to enter their input. Hence, since this system requires a willingness to act on the part of the collaborator, a relatively low participation rate is achieved leading to an absence of relevance and completeness of the data collected.

### BRIEF DESCRIPTION OF THE INVENTION

The purpose of the present invention is to provide a method for periodic information collection at least partially remedying the aforementioned disadvantages.

More specifically, the invention aims to provide a method for information collection with which to simultaneously satisfy a three-part problem.

First, the invention proposes to make a small intrusion on the user station and on the server, both minimizing the disruption produced by automatic display on the station before sending the response and also eliminating disruption during the remainder of the collection period after sending the response from automatic display on the station.

Next, the invention proposes to make the user manipulation for sending the response thereof easier by providing a multi-station accessibility for confirming and sending the response.

Finally, the invention proposes to provide, reliably and economically, the security of the information in the responses, by preventing the user from confirming more than one response per collection period, by means of both the storage mode and the consultation mode chosen for the response date, and also the synchronization between various stations associated with a single user.

According to the embodiments from the invention, it is going to involve in particular performing on each user's station a daily display of an interaction window, and removing this display from the interaction window by preventing its return for the remainder of the day once the user thereof has completed the interaction window by providing the requested information or at least a portion thereof.

For this purpose, the present invention proposes a method for periodic information collection on a network of computer stations by a computer server on this network, comprising, on the human machine interface of each station of the network, via an application on this station: an automatic display of an interaction window, requesting that the user of this station enter information, confirming the response of this user on the user's station and sending it to the server, where this automatic display is done at least once per collection period, unless there is an early and confirmed response from the user on the user's station or on another computer station which is also associated with this user, where this response confirmation, early or not, leads to: storage, on the server, of all or part of the information from the response sent; storage, on the user's station and on the server, of the user response date; the automatic disappearance of the interaction window; no automatic display of the interaction window during the remainder of the collection period; and the impossibility of confirming another response from this user, on the user's station or on another computer station which is also associated with this user, during the remainder of the collection period.

For this purpose, the present invention also proposes a computer tools suited for performing the method for periodic information collection according to any one of the preceding claims.

According to the preferred embodiments, the invention comprises one or more of the following characteristics which can be used separately or in partial combination with each other or all of them together, with one or another of the aforementioned objectives of the invention.

Preferably, the application consults locally, on this station, the response date of the user thereof in order to determine the next automatic display date of the interaction window, without querying the server during the remainder of the collection period after confirmation of the response.

In this way, the application contributes to further improving achieving a small intrusion on the station of the user as on the server, because of no superfluous communication between server and station, and also reliably and economically provides even better security for the response information while preventing any user from confirming more than one response per collection period, because of the mode of storage and consultation chosen for the response date.

In some embodiments of the invention, the application only queries the server when necessary, because the application has direct and local access to the latest response date of the user.

Preferably, this automatic display of an interaction window requesting that the user of this station enter information only imposes on the user a single required item of information, consisting of a single click by this user, for confirming the response thereof and sending it to the server.

In this way, the application contributes to further improving the ease of operation by the user for sending the response thereof by providing them a maximal simplicity for handling confirmation and response transmission.

In some embodiments of the invention, the confirmation of the response provided, even the sending of this response, can be obtained with a single required click in addition to constituting the core of this response itself.

Preferably, this automatic display is done randomly within a subperiod selected by this user, where this selected subperiod is stored in the user's station.

In this way the application contributes even better to providing, reliably and economically, the pertinence and security of the information in the responses, by preventing the user from either systematically biasing their response or confirming more than one response per collection period, by means of both the storage mode and the consultation mode for the response date, and also the synchronization between various stations associated with a single user.

In some embodiments of the invention, display of the interaction window is done each day, in a time range preselected by the user, but with random delivery within this preselected time range.

Preferably this subperiod set by this user is stored on the user's station, is not stored on the server, and preferably is only stored on their station.

Thus the confidentiality of providing information by the user is improved, since the traceability of the user is reduced, while also protecting the security of the information provided.

Preferably, each user can choose to send the response thereof anonymously or by name where this information about sending anonymously or sending by name is stored on the user's station, is not stored on the server, and is preferably stored only on the user's station.

Thus the security is improved by storing personal data in a more confidential way and the motivation to participate in the information collection is improved.

In some embodiments of the invention, the personal choices of the user, both concerning the intent thereof to remain anonymous and also the time chosen to provide the response thereof, remain on the station and are not stored on the server. Here again there is improved confidentiality.

Preferably, during this automatic display of the interaction window asking the user of this station to enter information to confirm the response of this user on the user's station and to send it to the server: the application also asks the user to enter an identifier and a password for the collection period every N collection periods, where N is larger than 5 and preferably larger than 10, even preferably larger than 20, in case of successful identification and authentication for a collection period, and the application next does not ask the user for either identification or authentication for other collection periods during the remaining time of the N collection periods.

Here again, this contributes to even further reducing the intrusion on the station of the user.

Preferably, in case of successful identification and authentication for a collection period, then for all the other collection periods during the remaining time of the N collection periods: the application uses a passphrase, which is generated after a successful identification and authentication by the user for one collection period, for direct communication between the user's station and the server without either identification or authentication by the user.

This small, maintained and improved, intrusion is consequently not done to the detriment of the security of the exchanges with which to guarantee the veracity and pertinence of the collected information.

In some embodiments of the invention, the user only needs to provide their identifier and password just one time, for a significant number of days, since for its part the application uses the passphrase for exchange between the client part thereof and the remote server. This results in a new improvement of the compromise between low intrusiveness on the user's station and guaranteeing security for new information collected on the user's station.

Preferably, first, before confirming and sending a response proposed by a user, the application verifies whether the user has already verified a response for the current collection period, next, before storing a response sent by the application, the server verifies whether the date of the response sent is consistent with the date of the server, since the response is not accepted by the server otherwise.

Thus, two security steps are done to prevent cheating by malicious users: first, a first application level step on the user's station, then in case of success, a second centralized step at the server level. In case of success of both security steps, the data provided by the user on the user's station are entered in the server.

Preferably, for information stored on the server, averages are collected by the server: by user, by grouping of users on one or more levels where the grouping of users to a single given level partitions users of the network of stations, for one or more given times, by collection period and by multiple collection periods on one or more levels, for one user or for one or more sets of users.

In that way, a statistical use—instead of personally identifying—of the information provided by the users and uploaded by the applications from their stations is possible. Parameters are monitored both by types of categories into which the various users of the network are grouped and also by time for observing changes in these parameters over time.

Preferably, the individual user data are stored on the station of that user and also on the station of the user managing a group of users at the first level including that user, but not on the station of a user managing a group of users at the second level including that user.

Thus, only the user involved with the information provided and the direct manager thereof can access this information, even if the user chose not to be anonymous (because if the user chose to be anonymous, even the direct manager thereof could not have access to it), whereas the manager or managers thereof positioned higher in the hierarchy cannot have access by name to this information, in order to avoid any managerial interference. Indirect managers can only have access to statistical information from the users.

Preferably, each user managing a grouping of users at level N, where N is a non-zero integer, can display, on their station or on another computer station which is also associated with that user, averages which were calculated by the server: by grouping of users at this level N, for one or several given times, and/or by grouping of users at the level corresponding to the grouping of all users of the network belonging to one country whether that country is the one of the user managing a grouping of users at that level N or another country, for one or more given times, and/or by grouping of users included in this grouping of users at this level N for one or more given times.

Thus, each manager can have statistical access to information concerning both the set of users whom the manager directly or indirectly manages, and also global sets of users such as all the users of the network or all the users of the network in one country.

Preferably, each user managing a grouping of users at level N, where N is a non-zero integer, cannot display, on their station or on another computer station which is also associated with that user, averages which were calculated by the server: by grouping of users at a level strictly above this level N, unless this grouping of users corresponds to the grouping of all users of the network belonging to one country whether that country is the one of the user managing a grouping of users at that level N or another country and/or by grouping of users included in another grouping of users from this level N.

On the other hand, in this way no manager can have statistical access to the information concerning limited sets of users for which the person is neither directly nor indirectly responsible.

In some embodiments of the invention, a manager can be provided this way the possibility of displaying their branch in whole or in part in the overall view of the company, without allowing them to go into the branches of other managers.

Preferably, some or all, preferably all of the averages calculated by the server are permanently stored on the server.

In that way, the number of dynamic calculations during the display of averages or results using these averages can be reduced.

Preferably, time series for one user or for a group of users are calculated by the server on request.

Thus time series charts can be displayed by category for certain information, even for all information, collected.

Preferably, different tables are used by the server and stored on the server, among them: a user table containing all the users of the network of stations, one or more tables of groupings containing all of the groupings, where each table of groupings links to the table of users, a table of response dates, a table of response information, possibly a security table containing a passphrase for each user avoiding asking the user to identify and authorize.

With these various tables, management of extensive information necessary to the smooth operation of the method for periodic information collection according to the invention can be optimized.

Preferably, the application is accessible by the user on the user's station belonging to the network of stations via the desktop of their station (“Windows desktop”; Windows is a registered trademark); the application is accessible to the user on another station associated with the user via a web portal.

Thus, this flexibility at the level of accessibility makes the operation of providing information by the user to the application even easier and friendlier, which as an indirect consequence leads to a higher participation rate of users in the collection of information which is higher and more spontaneous which has an indirect effect of improving the relevance and reliability of the information provided by the users.

Other features and advantages of the invention will appear upon reading the following description of a preferred embodiment of the invention, given as an example and with reference to the attached drawings.

### BRIEF DESCRIPTION OF THE DRAWINGS

FIG. 1 schematically shows an example of automatic display of an interaction window on the station of a user in a method for periodic information collection according to an embodiment of the invention.

FIG. 2 schematically shows an example of a user response to an interaction window on the station of a user in a method for periodic information collection according to an embodiment of the invention.

FIG. 3 schematically shows an example of confirmation of a user response to an interaction window on the station of a user in a method for periodic information collection according to an embodiment of the invention.

FIG. 4 schematically shows an example of configuration of a user response to an interaction window on the station of a user in a method for periodic information collection according to an embodiment of the invention.

FIG. 5 schematically shows an example of user authentication before response to an interaction window on the station of a user in a method for periodic information collection according to an embodiment of the invention.

FIG. 6 schematically shows another example of user authentication before response to an interaction window on the station of a user in a method for periodic information collection according to an embodiment of the invention.

FIG. 7 schematically shows another example of user response to an interaction window on the station of a user in a method for periodic information collection according to an embodiment of the invention.

FIG. 8 schematically shows another example of confirmation of a user response to an interaction window on the station of a user in a method for periodic information collection according to an embodiment of the invention.

FIG. 9 schematically shows an example of display of collected data on the station of a user in a method for periodic information collection according to an embodiment of the invention.

FIGS. 10 to 17 schematically show other examples of display of collected data on the station of a user in a method for periodic information collection according to an embodiment of the invention.

18 to 21 schematically show other examples of display of collected data on another station associated with a user in a method for periodic information collection according to an embodiment of the invention.

FIG. 22 schematically shows an example of three tables and the relationships thereof in a method for periodic information collection according to an embodiment of the invention.

FIGS. 23 to 30 schematically show other examples of tables storing information useful for implementation of the method for periodic information collection according to an embodiment of the invention.

FIGS. 31 to 34 schematically show various examples of sets of tables for several periods, storing information useful for implementation of the method for periodic information collection according to an embodiment of the invention.

FIGS. 35 to 40 schematically show various examples of routines useful for implementation of the method for periodic information collection according to an embodiment of the invention.

FIG. 41 schematically shows an example of a management tree structure for grouping of users used in a method for periodic information collection according to an embodiment of the invention.

FIG. 42 schematically shows another example of a routine useful for implementation of the method for periodic information collection according to an embodiment of the invention.

FIG. 43 schematically shows an example of an average calculation done during implementation of the method for periodic information collection according to an embodiment of the invention.

FIG. 44 schematically shows another example of automatic display of an interaction window on the station of a user in a method for periodic information collection according to an embodiment of the invention.

FIG. 45 schematically shows an example of passphrase storage for a user, during implementation of the method for periodic information collection according to an embodiment of the invention.

FIG. 46 schematically shows another example of automatic display of an interaction window on the station of a user in a method for periodic information collection according to an embodiment of the invention.

FIG. 47 schematically shows another example of configuration of a user response to an interaction window on the station of a user in a method for periodic information collection according to an embodiment of the invention.

### LIST OF REFERENCES FROM THE FIGURES

1 interaction window

2 screen

3 toolbar

4 question

5 comment field

6 list of icons

7 selection cursor

8 message displayed

9 anonymity configuration

10 time range configuration

11 confirmation button

12 identifier field

13 password field

14 chart

15 period tab

16 participation list

17 detailed data list

18 hierarchical tree

19 additional data from the chart

20 portable phone screen

21 table of users

22 tree structure table

23 table of geographic sites

24 pointer

25 table of managers

26 table of detailed data

27 table of response dates

28 table of passphrases

29 table of errors

30-31-32/ tables of statistics by country and period

33-34-35/ tables of statistics by functional manager and period

36-37-38/ tables of overall statistics by direct manager and period

39-40-41/ tables of detailed statistics by direct manager and period

42 to 83 functional blocks in the flow of steps

84 table for assignment of managers

85-86-87 columns from the table for assignment of managers

88 calculation storage table

89 passphrase table

### DETAILED DESCRIPTION OF THE INVENTION

The present invention relates to a method for periodic information collection in order to get a measurement of the well-being of the contributors, subsequently concatenated to get a view by manager and by country. This method for periodic information collection is called “WellBeing@Work” (“BienEtre@Travail” in French).

Globalization motivates users of a network and their managers to change and work remotely, with their teams throughout the world and a minimum of interaction between them.

The managers have no way of assessing the well-being of the users at work other than through a survey sent manually once per year.

The method for periodic information collection for getting a measure of the well-being of the contributors uses both a “Windows Desktop” (Windows is a registered trademark) type application which is installed on the computer stations of users and which is used to submit their level of well-being at work with a click, and also by a website with which contributors can enter their vote for managers to view the inputs from their team, and for managers of managers to view the well-being on a global scale.

The method for periodic information collection for getting a measure of the well-being of the contributors is therefore composed of a “Windows” (Windows is a registered trademark) client which is installed on the positions and also on a web portal.

One of the main attractions of the “Windows Desktop” client (Windows is a registered trademark) is that it avoids the need for the user to connect daily to a portal or application (“Pull” mode), resulting in being forgotten. Because of this, the tool displays itself every day (“Push” mode) to call on the user.

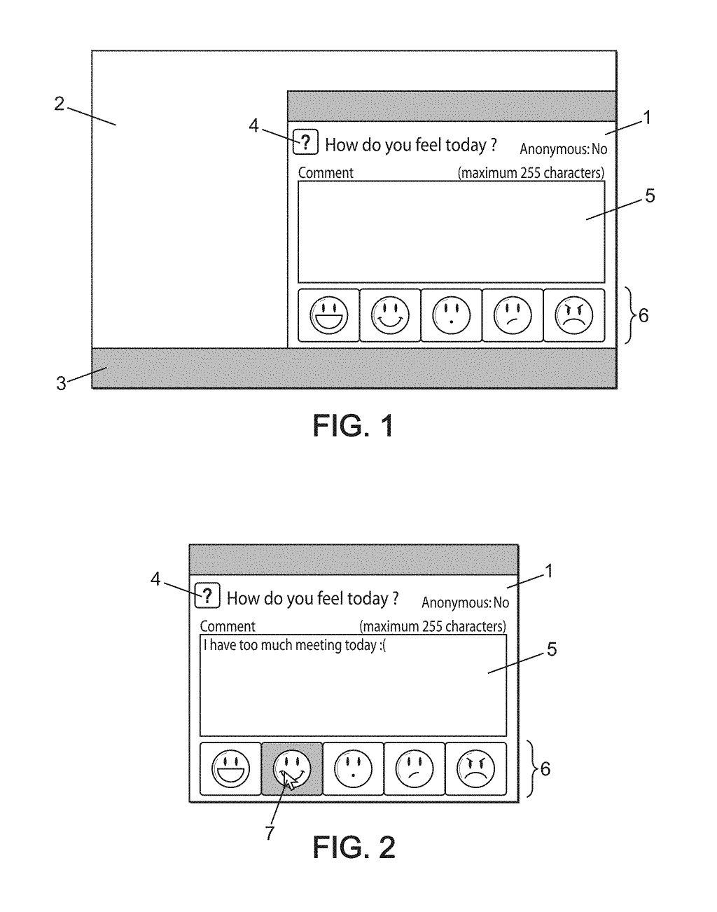

The step-by-step operation for the contributor is now going to be described. Once per day, the application automatically starts and is displayed at the bottom right of the desktop of their computer station, as can be seen in FIG. 1.

FIG. 1 schematically shows an example of automatic display of an interaction window on the station of a user in a method for periodic information collection according to an embodiment of the invention.

An interaction window 1 is displayed on the screen 2 which has a toolbar or taskbar 3 in the bottom part thereof. The contributor is then asked by a question 4 to enter an optional comment 5 and then to click on the smiley 6 which best corresponds to them. Only the last action mentioned is required, since the purpose of this application is to be the least intrusive possible. After clicking, the application displays a confirmation message and automatically disappears.

The user can also click on the cross “X” in the top right to reduce the application which will not call on the user again until the following day. To send their entry, the user will then have to double-click on the icon on the taskbar 3 or use the keyboard shortcut.

FIG. 2 schematically shows an example of a user response to an interaction window on the station of a user in a method for periodic information collection according to an embodiment of the invention.

Entering a message is optional, only the click on the corresponding smiley is required. This click on the smiley, done with the selection cursor 7, simultaneously sends the information provided to the server.

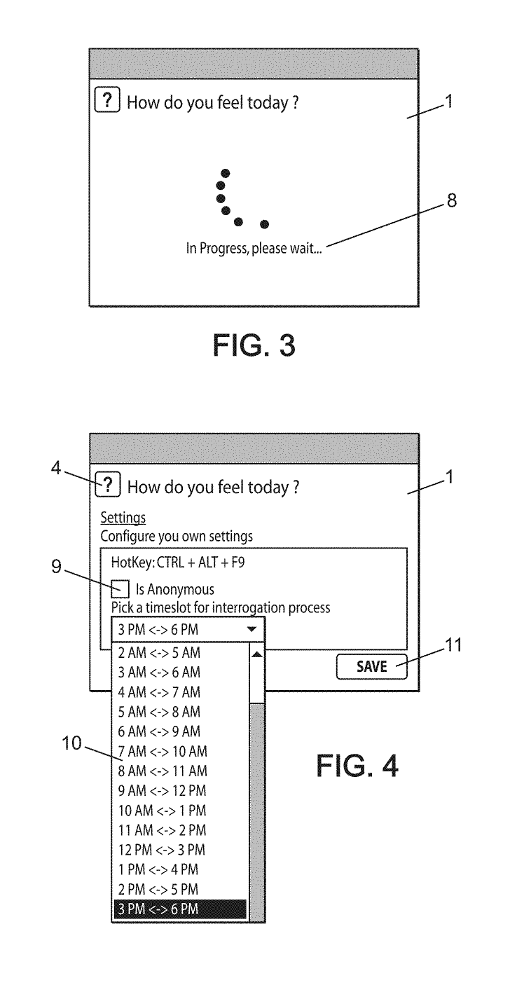

FIG. 3 schematically shows an example of confirmation of a user response to an interaction window on the station of a user in a method for periodic information collection according to an embodiment of the invention. A message 8 confirms that the information is being sent.

FIG. 4 schematically shows an example of configuration of a user response to an interaction window on the station of a user in a method for periodic information collection according to an embodiment of the invention.

The user can also choose an anonymous configuration 9 and a time range configuration 10.

To be the least intrusive possible, the user can configure the time during which the tool can call on them. During this time range selected by the user, the interaction window 1 is going to display on the user's screen 2 every day randomly, and it does this to avoid displaying daily after recurring events which could be personal, like for example a traffic jam on the road, an unwanted meeting, or something else which could falsify the relevance of the information collected.

It is also possible for the user to stipulate that each time they send information through this application, it is made anonymous so that it is unidentifiable by their manager. The manager will in fact see a score 6 and a comment 5, if the user wrote one, but will not be capable of identifying the user.

It is possible to bring up the application in other ways than by waiting for it to display automatically. To do that, a specific combination of keystrokes can for example activate the application.

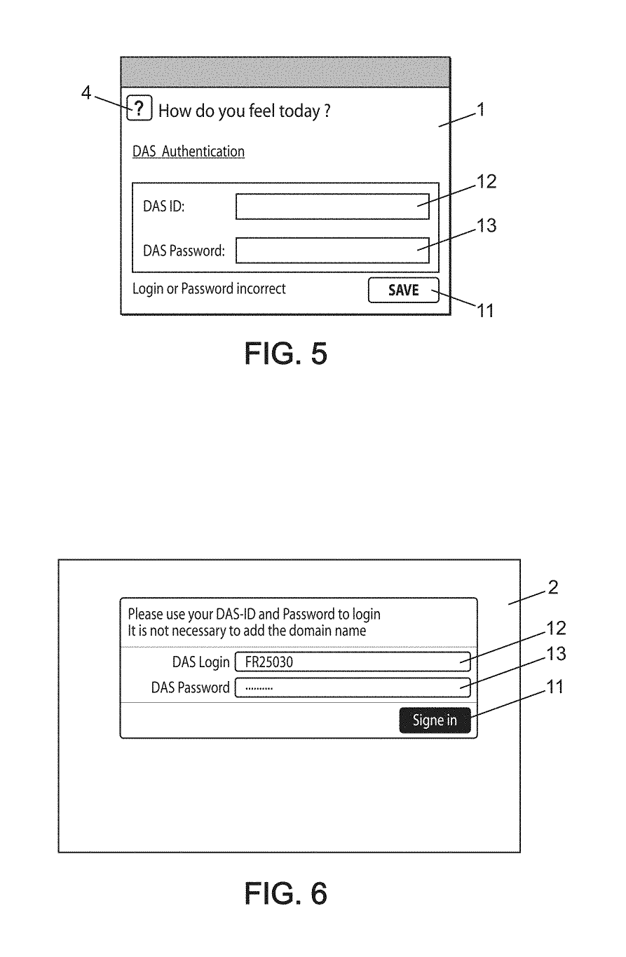

FIG. 5 schematically shows an example of user authentication before response to an interaction window on the station of a user in a method for periodic information collection according to an embodiment of the invention.

When the user first uses the application, they will be asked for their identifier 12 (“Login”) and their password 13 (“DAS Password”). Once entered, they will not be asked again for a variable time, configurable by the system administrators, which could be for example 20 days.

Using the web portal, contributors are first able to do the same actions as on the application on their station, but on a website, from a computer, for example, on an off-network customer site, from a mobile phone or from a tablet, and also able to define a functional manager in addition to their hierarchical manager.

Next the hierarchal or functional managers of contributors can both view the average well-being at work of their team, and also the comments which were sent by the contributors on their team and can also display the detail of the entries from their contributors.

Using the web portal, managers of managers are also able to take additional actions among which are the ability to view the concatenated average of the well-being at work of the N-X (persons assigned closely or remotely to the manager N).

Finally using the web portal, directors are able to view a world map with the score for each country and also a chart by country or a world chart.

FIG. 6 schematically shows another example of user authentication before response to an interaction window on the station of a user in a method for periodic information collection according to an embodiment of the invention.

The contributor connects to the web portal and enters their identifier 12 and password 13.

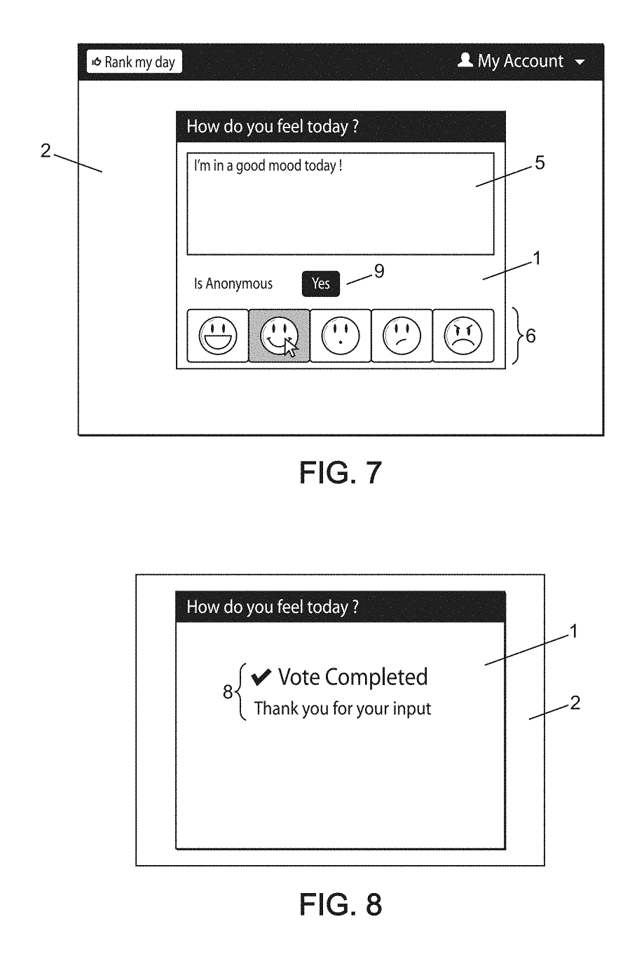

FIG. 7 schematically shows another example of user response to an interaction window on the station of a user in a method for periodic information collection according to an embodiment of the invention.

The contributor can next enter a comment 5, which is optional, choose whether they want their entry to be anonymous or not by using the field 9 whose content remains stored on the device used, and then clicking on the smiley 6 corresponding to their mood for the day.

FIG. 8 schematically shows another example of confirmation of a user response to an interaction window on the station of a user in a method for periodic information collection according to an embodiment of the invention.

A confirmation message 8 appears. It is not possible for the contributor to submit their choice again during a single day.

The hierarchical or functional manager has access to the concatenation of the data related to their team and also the comments and history. If a contributor changes manager, the new manager cannot display the history of the contributor.

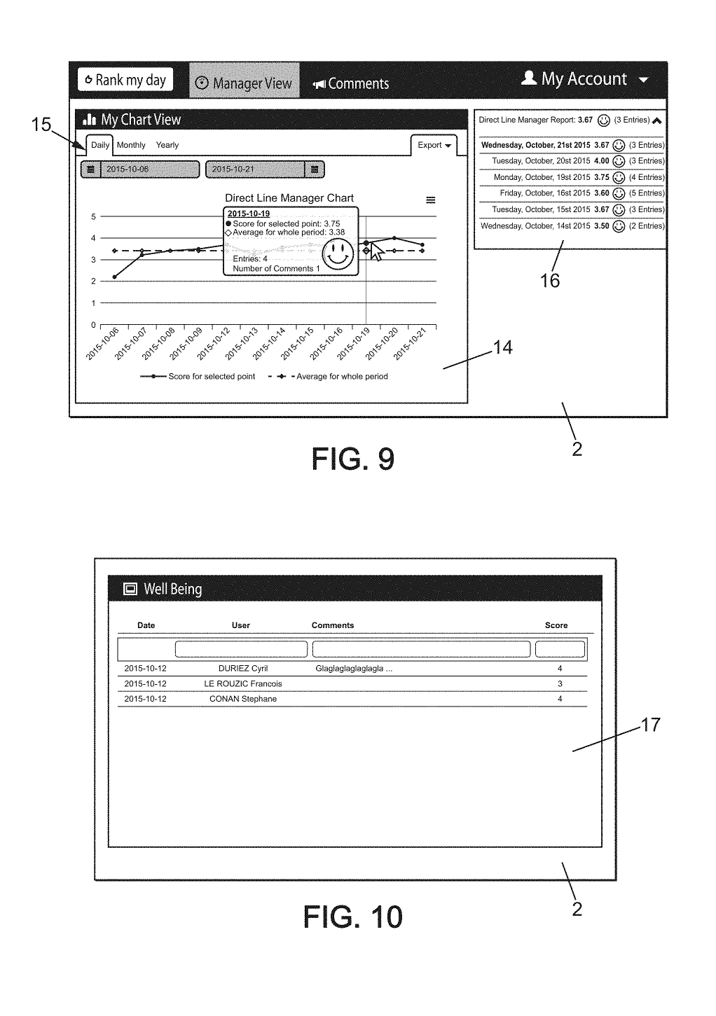

FIG. 9 schematically shows an example of display of collected data on the station of a user in a method for periodic information collection according to an embodiment of the invention.

The manager can view the history 14 of the concatenated entries using a chart and also view the details 16 by day, month and year via the period tab 15. If the manager is both the hierarchical and functional manager, the set of data is concatenated. Sliding the mouse over the chart, it is possible to see at a glance the average for the day, the average over a given period, the number of entries and the number of comments. It is also possible to export all the data displayed along with the charts.

FIG. 10 schematically shows another example of display of data collected on the station of a user in a method for periodic information collection according to an embodiment of the invention.

By clicking on the chart, on one day, it is possible to view the details 17 of the entries from each contributor.

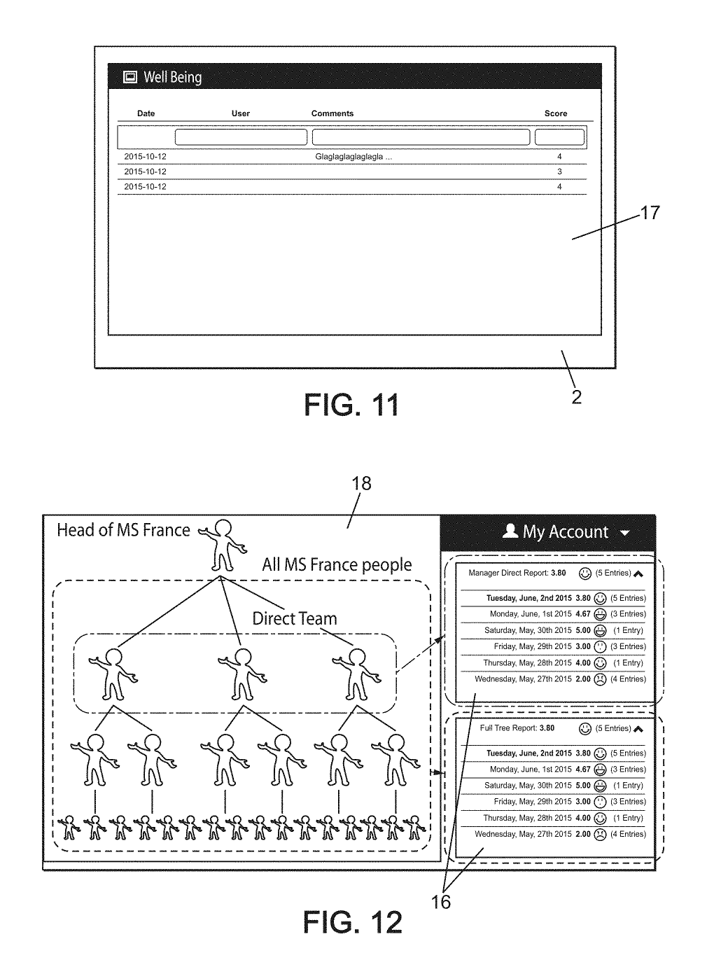

FIG. 11 schematically shows another example of display of data collected on the station of a user in a method for periodic information collection according to an embodiment of the invention.

If only one contributor has sent data anonymously and it is easily identifiable, the set of names will not be displayed, as can be seen in the detail 17.

FIG. 12 schematically shows another example of display of data collected on the station of a user in a method for periodic information collection according to an embodiment of the invention. The drawing 18 from FIG. 12 helps to visualize the role of manager of managers in the application.

Since the manager of managers is a manager of contributors, the manager has the possibility to be able to view the data 16 of the contributors directly assigned to them, just like any other manager.

In contrast, as a manager of managers, the manager also has the possibility of viewing the concatenation of all of the data 16 from collaborators who are assigned to them, directly or indirectly, in order to allow them to have an overall view of the state of their entity.

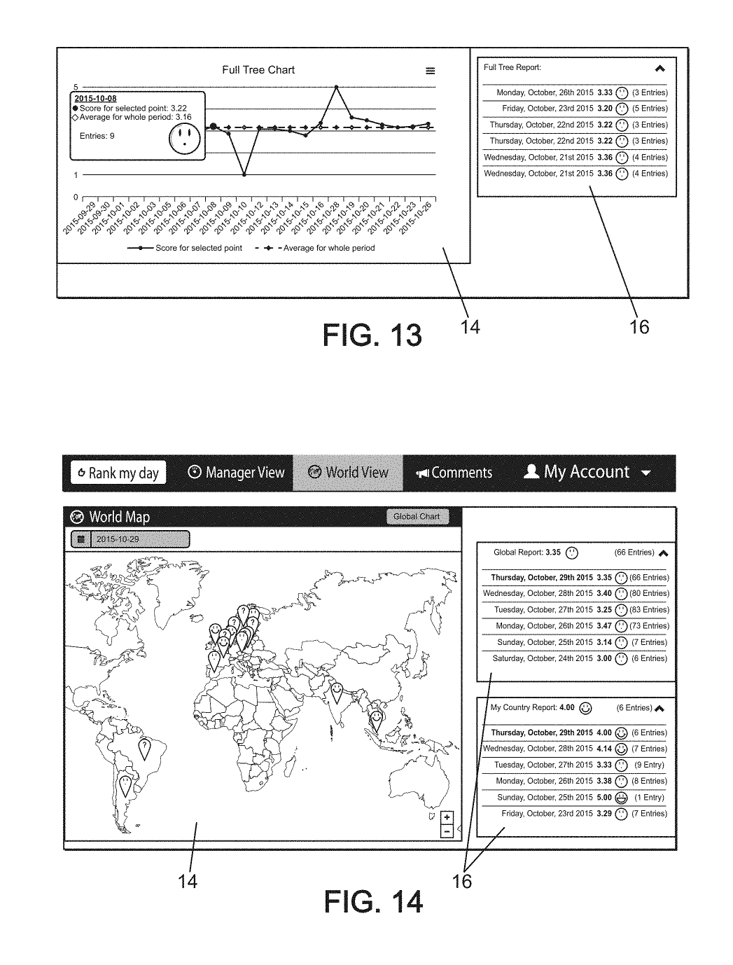

FIG. 13 schematically shows another example of display of data collected on the station of a user in a method for periodic information collection according to an embodiment of the invention.

On the graphical part 14 “Full Tree Chart,” it is possible to view the score and average and also the number of entries. In contrast, to avoid any managerial intrusion, it is not possible however to view either the detail or even the comments.

In contrast, as a manager of managers, the manager also has the possibility of viewing the concatenation of all of the data 16 from collaborators who are assigned to them, directly or indirectly, in order to allow them to have an overall view of the state of their entity.

FIG. 14 schematically shows another example of display of data collected on the station of a user in a method for periodic information collection according to an embodiment of the invention.

The concatenation of the well-being of contributors globally can be seen on the world map 14, where each smiley corresponds to one country. Note that a smiley for France does not mean that all the people work in France or that they work for the subsidiary based in France, but that France is their country of assignment.

This map 14 represents the well-being of the country on the network for the selected day. On the right, the group 16 on top summarizes the global well-being, the score displayed therefore represents the concatenation of all contributors from the company, meaning all the users of the network. The frame on the bottom 16 represents the well-being of the country to which the connected person is assigned.

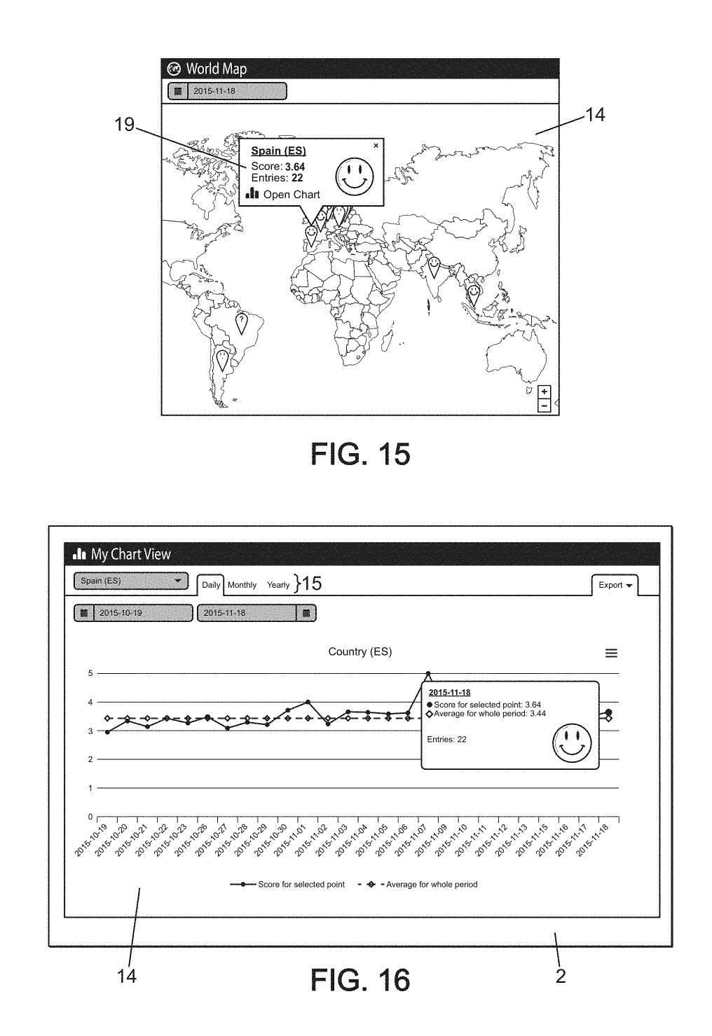

FIG. 15 schematically shows another example of display of data collected on the station of a user in a method for periodic information collection according to an embodiment of the invention.

By clicking on the smiley of a country from the map 14, the user gets, in a group 19, the average for the day selected and the number of entries for the day selected in real time. By clicking on “Open Chart,” the graph associated with the country appears as shown on FIG. 16.

FIG. 16 schematically shows another example of display of data collected on the station of a user in a method for periodic information collection according to an embodiment of the invention.

By clicking on “Open Chart,” the chart 14 associated with the corresponding country appears providing a day by day, month by month or year by year monitoring of a geographic area.

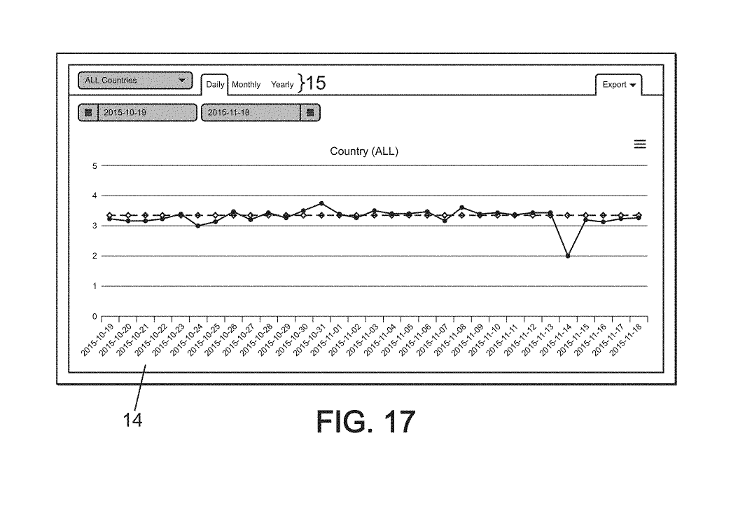

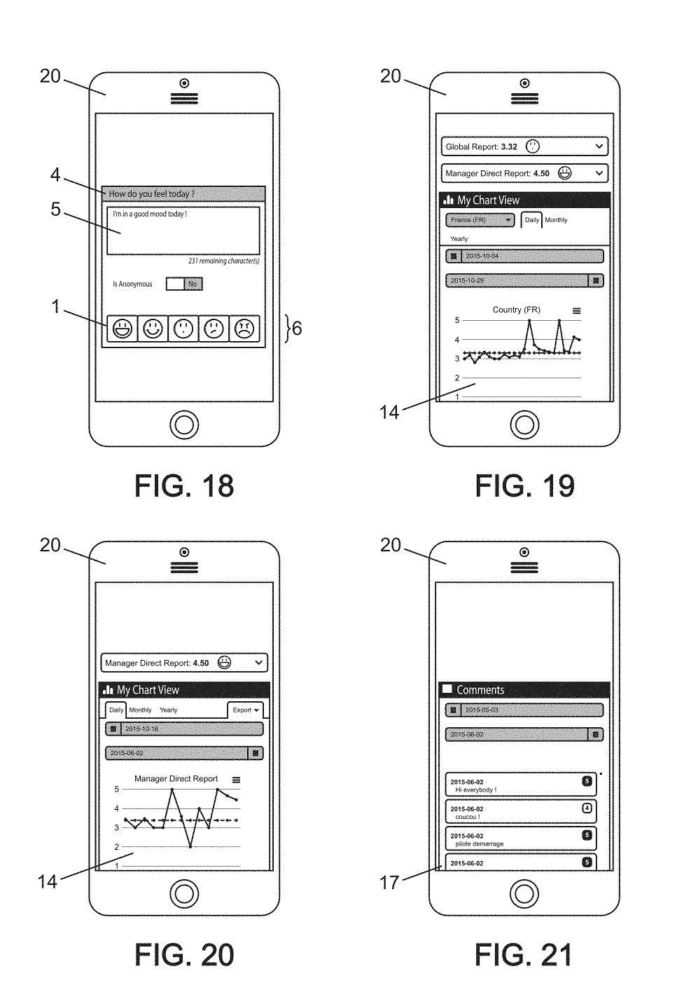

FIG. 17 schematically shows another example of display of data collected on the station of a user in a method for periodic information collection according to an embodiment of the invention.

It is also possible to display the chart 14 connected to the company as a whole.

18 to 21 schematically show other examples of display of collected data on another station associated with a user in a method for periodic information collection according to an embodiment of the invention.

The user can access the same elements on the interface 20 of a smart phone or mobile phone as on their station, specifically interaction window 1, question 4, comment field 5, list of icons to select 6, graphs 14 and list of data 17. The web portal adapts to the device used for connecting to it. It is therefore compatible with personal computers, mobile phones and tablets.

The database storing all the information is organized using a set of tables. The “Idap” tables are tables reflecting the content of the company's LDAP. They provide access to important information like the manager of the contributor and their country of assignment.

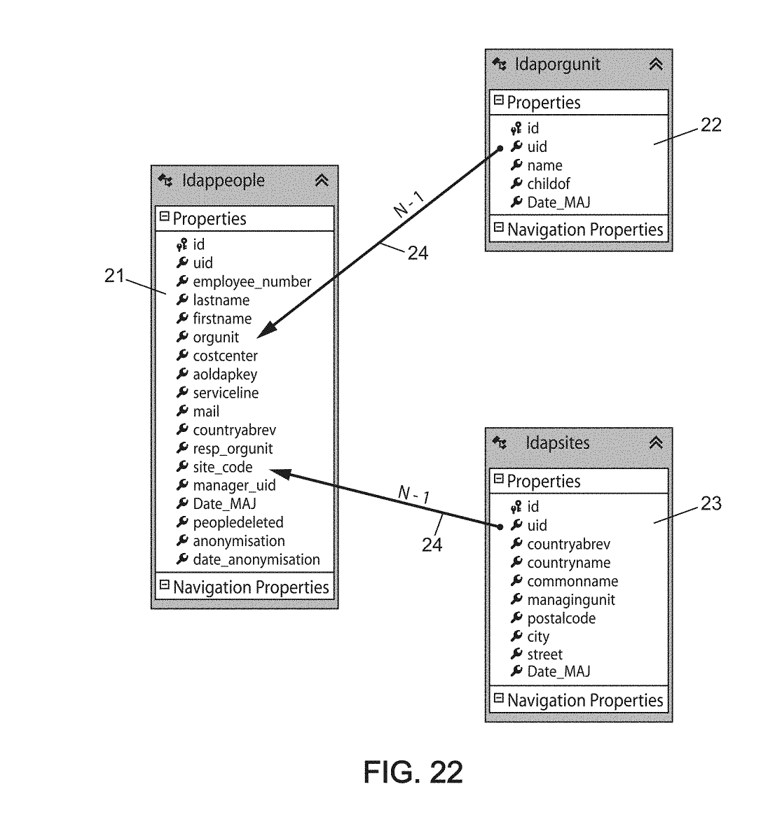

FIG. 22 schematically shows an example of three tables and the relationships thereof in a method for periodic information collection according to an embodiment of the invention. Tables 21, 22 and 23 are linked to each other. Table 22 points to table 21 by means of a pointer 24. Similarly, table 23 points to table 21 by means of a pointer 24.

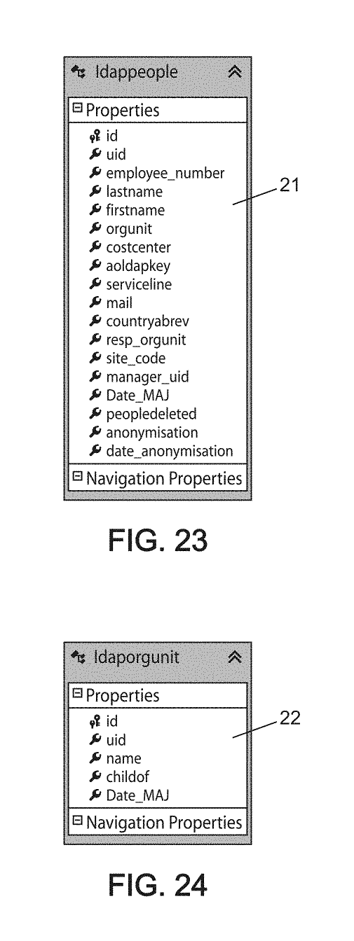

FIG. 23 schematically shows another example of a table storing information useful for implementation of the method for periodic information collection according to an embodiment of the invention.

Table 21 contains all users of the network and also the identifier of their hierarchical manager. It also shows the people who have left the company and the date on which they left, to make their entries anonymous.

Now, here is the description of the various fields from table 21:

Id: auto incrementing ID, unique for each contributor and providing a link with the other tables

Uid: company IT identifier of the contributor

Employee_number: human resource registration number of the contributor, different from their computer identifier

Lastname: employee's family name

Firstname: employee's first name

Orgunit: organizational unit of the contributor

Costcenter: cost center, which is an optional field

Aoldapkey: unique key for the contributor in the LDAP

Serviceline: service line of the contributor at the group unit level

Mail: email address of the contributor

Countryabrev: abbreviation of the country to which the contributor is assigned, for example: FR for France, EN for England, BE for Belgium

Sitecode: unique code for the geographic site to which the contributor is assigned

Manager_uid: Uid of the manager to whom the contributor is assigned

Date_MAJ: Date on which the information for the contributor was updated, unless there had been a change, for example, with the manager or the entity

Peopledeleted: logical field, 1 if the contributor had left the company

Anonymisation: if the user asked to be anonymous, this field changes to 1

Date_anonymisation: date on which the contributor asked to have their past entries made anonymous.

FIG. 24 schematically shows another example of a table storing information useful for implementation of the method for periodic information collection according to an embodiment of the invention.

Table 22 contains all of the organizational units together with the parent identifier for the unit, so that the entirety of the organizational tree structure can be reconstructed and the contributors associated with it.

Now, here is the description of the various fields from table 22:

Id: auto incrementing ID, unique for each organization and providing a link with the other tables

Uid: IT identifier unique to each organization

Name: name of the organization

Childof: the parent Uid of the organization

Date_MAJ: date of the last organizational update

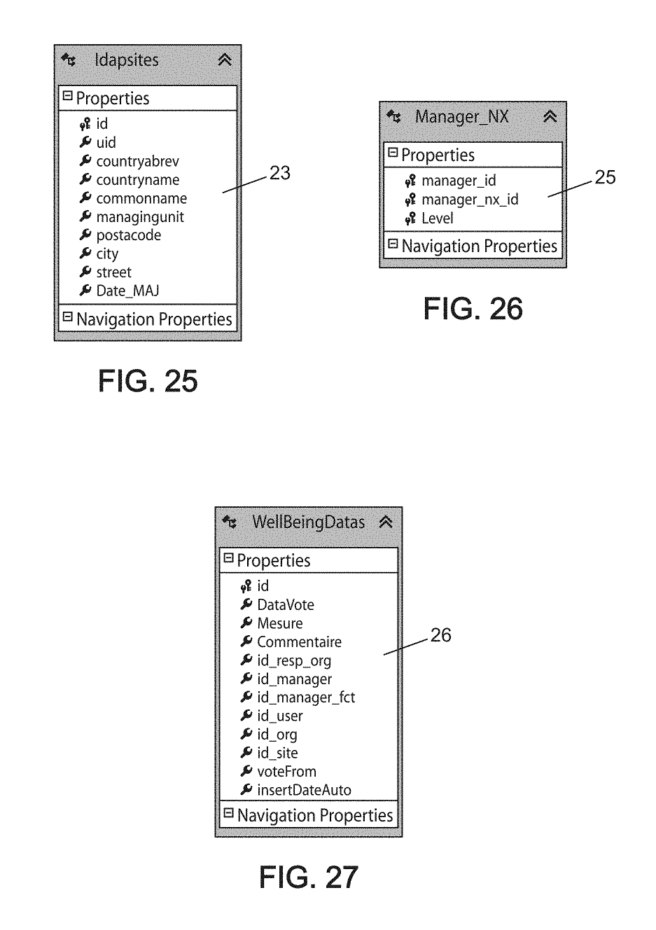

FIG. 25 schematically shows another example of a table storing information useful for implementation of the method for periodic information collection according to an embodiment of the invention.

Table 23 contains all of the company's geographic sites, in order to define what site/country a contributor belongs to.

Now, here is the description of the various fields from table 23:

Id: auto incrementing ID

Uid: IT identifier in the LDAP with which to associate a contributor to a geographic site

Countryabrev: abbreviation for the country, for example FR, EN, etc.

Countryname: full name of the country

Commonname: city of the site

Managingunit: organizational unit which manages the site

Postalcode: postal code of the site

City: region

Street: city

Date_MAJ: date of last update with Idap

FIG. 26 schematically shows another example of a table storing information useful for implementation of the method for periodic information collection according to an embodiment of the invention.

Table 25 contains the set of managers from the company, the managers associated with them and also their hierarchical level.

Now, here is the description of the various fields from table 25:

Manager_id: id of the manager

Manager_nx_id: id of the manager N-X

Level: level of the manager n-X, where X is there hierarchical level relative to the associated manager

FIG. 27 schematically shows another example of a table storing information useful for implementation of the method for periodic information collection according to an embodiment of the invention.

Table 26 contains the set of entries for contributors. This is the source table which will be used subsequently by the algorithms for calculation stored in the pre-calculation tables.

Now, here is the description of the various fields from table 26:

Id: auto incrementing ID

DateVote: date of the vote (yyy-MM-dd: four digits for the year, then two digits for the month, finally two digits for the day) at the local time of the contributor

Mesure: associated score ranging from 1 to 5

Commentaire: optional commentary sent by the contributor

id_resp_org: id of the organizational manager

id_manager: id of the manager to whom the score is going to be assigned (“solid line manager”)

id_manager_fct: id of the manager to whom the score is going to be assigned (“dotted line manager”)

id_user: id of the user who voted; if the user is anonymous, then the field is 0.

id_org: id of the organizational unit

id_site: id of the associated site, for the association to the country.

voteFrom: “Software” if the vote comes from the client on the station, “Web” if it comes from the web portal.

insertDateAuto: date of insertion in the database at the local server time

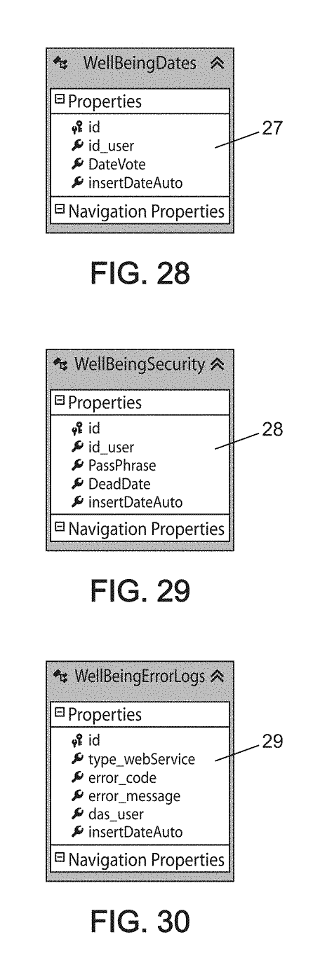

FIG. 28 schematically shows another example of a table storing information useful for implementation of the method for periodic information collection according to an embodiment of the invention.

Table 27 contains the last date of voting for the contributors, this way the possibility of voting twice on the same day can be avoided and also the client on the station to not display if a contributor voted through the web portal.

Now, here is the description of the various fields from table 27:

Id: auto incrementing ID

Id_user: database identifier of the user

DateVote: date of the last entry from the contributor (yyy-MM-dd at the local time of the contributor's device)

insertDateAuto: server date and time of the last entry from the contributor

FIG. 29 schematically shows another example of a table storing information useful for implementation of the method for periodic information collection according to an embodiment of the invention.

Table 28 contains the passphrase associated with each contributor. During LDAP authentication of the client on their station, a “passphrase” key is generated so that the client won't request the password from the user again every day.

Now, here is the description of the various fields from table 28:

Id: auto incrementing ID

Id_user: database id of the user

PassPhrase: unique passphrase generated by the server

DeadDate: date on which the passphrase becomes obsolete and the user has to enter their identifier and password again.

insertDateAuto: server date of the last update

FIG. 30 schematically shows another example of a table storing information useful for implementation of the method for periodic information collection according to an embodiment of the invention.

Table 29 contains information about errors which may have happened when the user tried to vote, that is provided the information needing to be collected.

Now, here is the description of the various fields from table 29:

Id: auto incrementing ID

Id_user: database id of the user

Error_code: error code from the web portal or client on the user's computer station

Error_message: error message detail, distinguishing between for example an authentication error, access refusal, expired passphrase, etc.

Das_user: user password

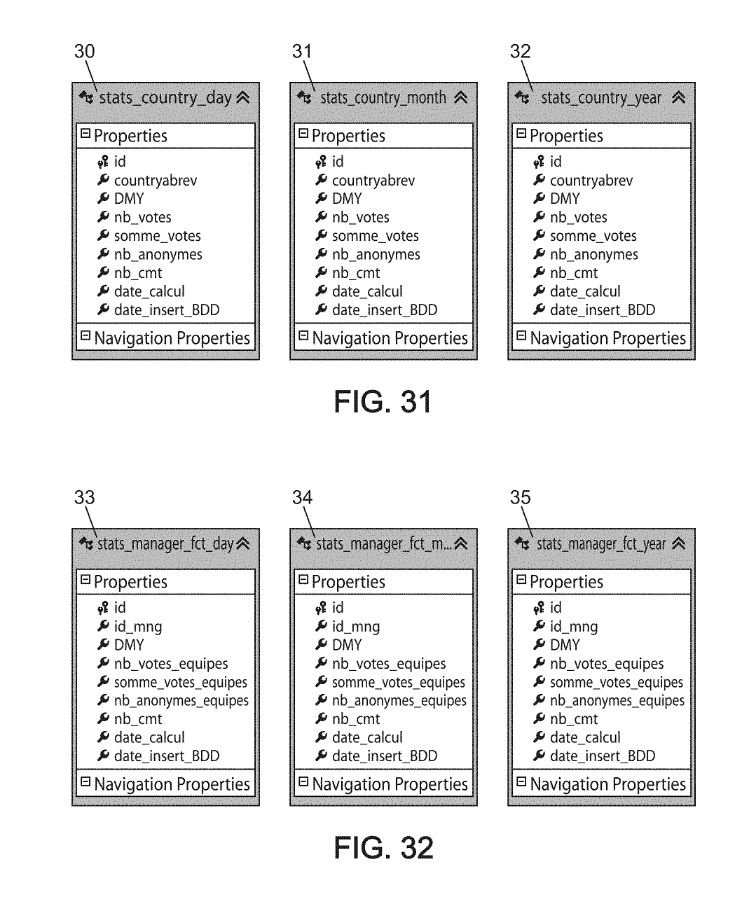

FIGS. 31 schematically shows a set of tables for several periods, storing information useful for implementation of the method for periodic information collection according to an embodiment of the invention.

The tables 30 to 32 “stats_country_day”, “stats_country_month” and “stats_country_year” contain the results of batches which run continuously with the entirety of concatenated votes, by country, to accelerate the display of pages. The data are distributed in each table by day, month and year in each of the corresponding tables 30 to 32.

Now, here is the description of the various fields from tables 30 to 32:

Id: auto incrementing ID

Countryabrev: abbreviation for the country, for example FR, EN, etc.

DMY: relevant date (yyyy-MM-dd or yyyy-MM or yyyy)

Nb_votes: number of votes

Somme_votes: total of all votes

Nb_anonymes: number of contributors who entered anonymously

Nb_cmt: number of comments

Date_calcul: server date associated with the calculation

Date_insert_BDD: Date of the last server update, since the calculations are done over 48 hours to incorporate all time zones of the network

FIGS. 32 schematically shows a set of tables for several periods, storing information useful for implementation of the method for periodic information collection according to an embodiment of the invention.

The tables 33 to 35 “stats_country_fct_day”, “stats_country_fct_month” and “stats_country_fct_year” contain the results of batches which run continuously with the entirety of concatenated votes, by functional and therefore indirect manager, to accelerate the display of pages. The data are distributed in each table by day, month and year in each of the corresponding tables 33 to 35.

Now, here is the description of the various fields from tables 33 to 35:

Id: auto incrementing ID

Id_mng: database of the manager

Countryabrev: abbreviation for the country, for example FR, EN, etc.

DMY: relevant date (yyyy-MM-dd or yyyy-MM or yyyy)

Nb_votes: number of votes

Somme_votes: total of all votes

Nb_anonymes_equipes: number of contributors who entered anonymously

Nb_cmt: number of comments

Date_calcul: server date associated with the calculation

Date_insert_BDD: Date of the last server update, since the calculations are done over 48 hours to incorporate all time zones of the network

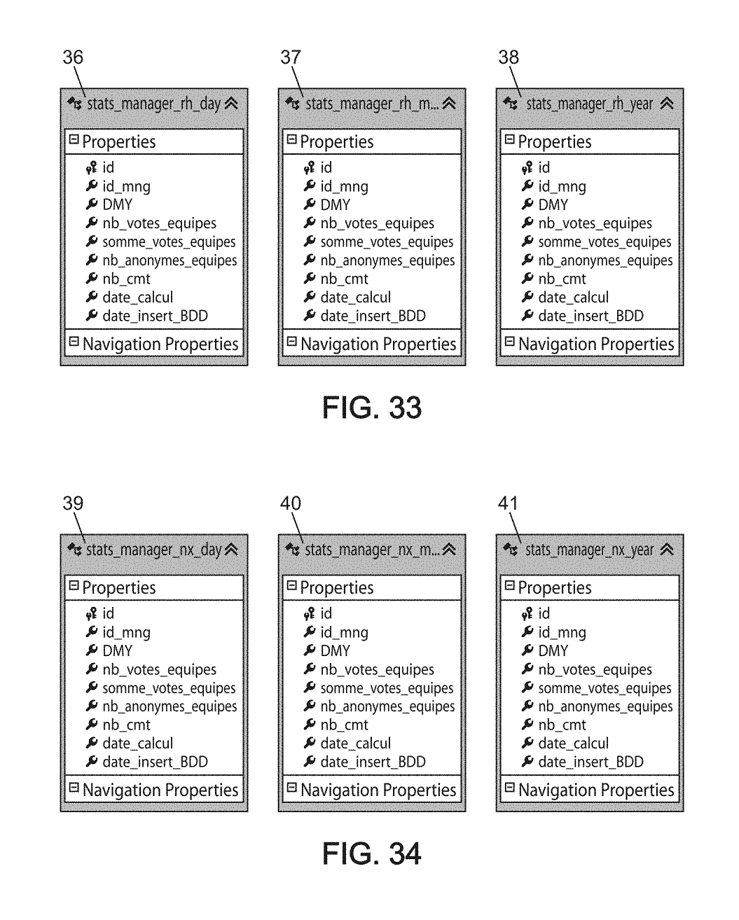

FIGS. 33 schematically shows a set of tables for several periods, storing information useful for implementation of the method for periodic information collection according to an embodiment of the invention.

The tables 36 to 38 “stats_country_rh_day”, “stats_country_rh_month” and “stats_country_rh_year” contain the results of batches which run continuously with the entirety of concatenated votes, by direct manager, to accelerate the display of pages. The data are distributed in each table by day, month and year in each of the corresponding tables 36 to 38.

Now, here is the description of the various fields from tables 36 to 38:

Id: auto incrementing ID

Id_mng: database ID of the manager

Countryabrev: abbreviation for the country, for example FR, EN, etc.

DMY: relevant date (yyyy-MM-dd or yyyy-MM or yyyy)

Nb_votes: number of votes

Somme_votes: total of all votes

Nb_anonymes_equipes: number of contributors who entered anonymously

Nb_cmt: number of comments

Date_calcul: server date associated with the calculation

Date_insert_BDD: Date of the last server update, since the calculations are done over 48 hours to incorporate all time zones of the network

FIGS. 34 schematically shows a set of tables for several periods, storing information useful for implementation of the method for periodic information collection according to an embodiment of the invention.

The tables 39 to 41 “stats_country_nx_day”, “stats_country_nx_month” and “stats_country_nx_year” contain the results of batches which run continuously with the entirety of concatenated votes, for each direct manager, over the entirety of the hierarchical line below the manager. The data are distributed in each table by day, month and year in each of the corresponding tables 39 to 41.

Now, here is the description of the various fields from tables 39 to 41:

Id: auto incrementing ID

Id_mng: database ID of the manager

Countryabrev: abbreviation for the country, for example FR, EN, etc.

DMY: relevant date (yyyy-MM-dd or yyyy-MM or yyyy)

Nb_votes: number of votes

Somme_votes: total of all votes

Nb_anonymes_equipes: number of contributors who entered anonymously

Nb_cmt: number of comments

Date_calcul: server date associated with the calculation

Date_insert_BDD: Date of the last server update, since the calculations are done over 48 hours to incorporate all time zones of the network

The database contains tables dedicated to LDAP synchronization. A script loads every night to synchronize them with each other.

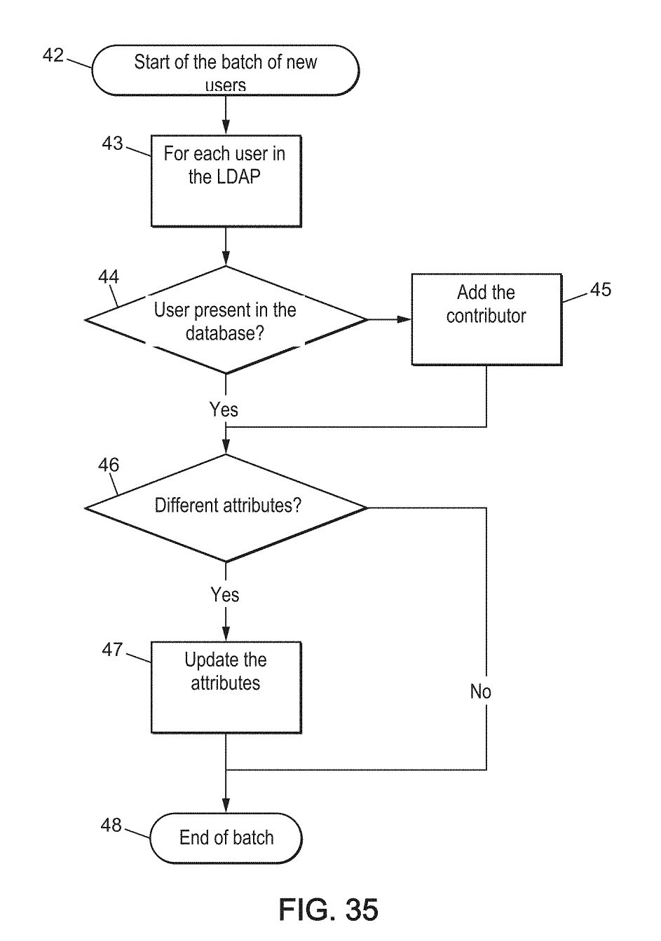

FIG. 35 schematically shows an example of a routine useful for implementation of the method for periodic information collection according to an embodiment of the invention. This routine is used for the addition of new contributors and for the update of existing contributors, where these contributors are users of computer positions on the network.

The routine starts at functional block 42 with a batch of new users. The users are taken one by one at block 43. For each user, their presence in the database is verified in step 44. If they are absent, the user or contributor is added in step 45. In step 46, the attributes of the user are verified and if needed could be followed by a step 47 of updating the attributes of the user. The routine ends at the end of batch functional block 48, when this routine has gone through all the users in the batch.

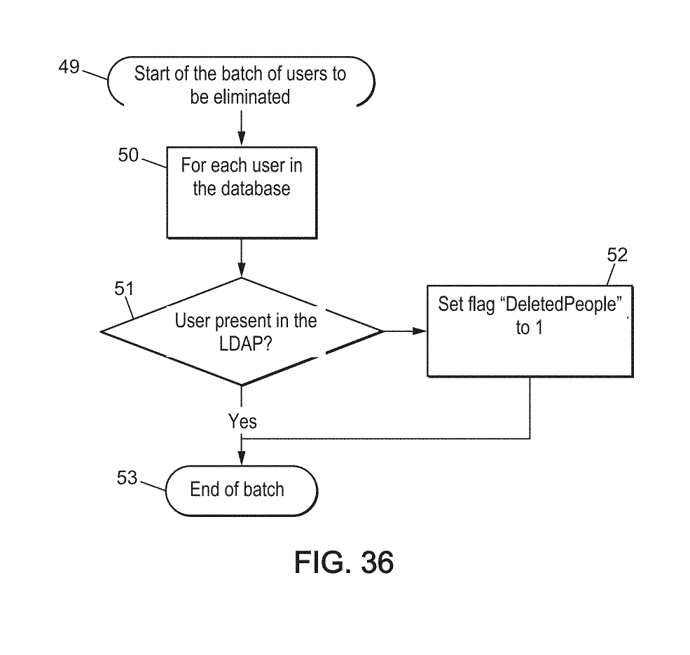

FIG. 36 schematically shows an example of a routine useful for implementation of the method for periodic information collection according to an embodiment of the invention. This routine is used for eliminating contributors who have left the company, and therefore left the network to which their computer station belonged.

The routine starts at functional block 49 with a batch of former users to be eliminated because they have left the network. The users are taken one by one at block 50. For each user, their presence in the database is verified in step 51. If they are present, the user or contributor is eliminated in step 52. The routine ends at the end of batch functional block 53, when this routine has gone through all the users in the batch.

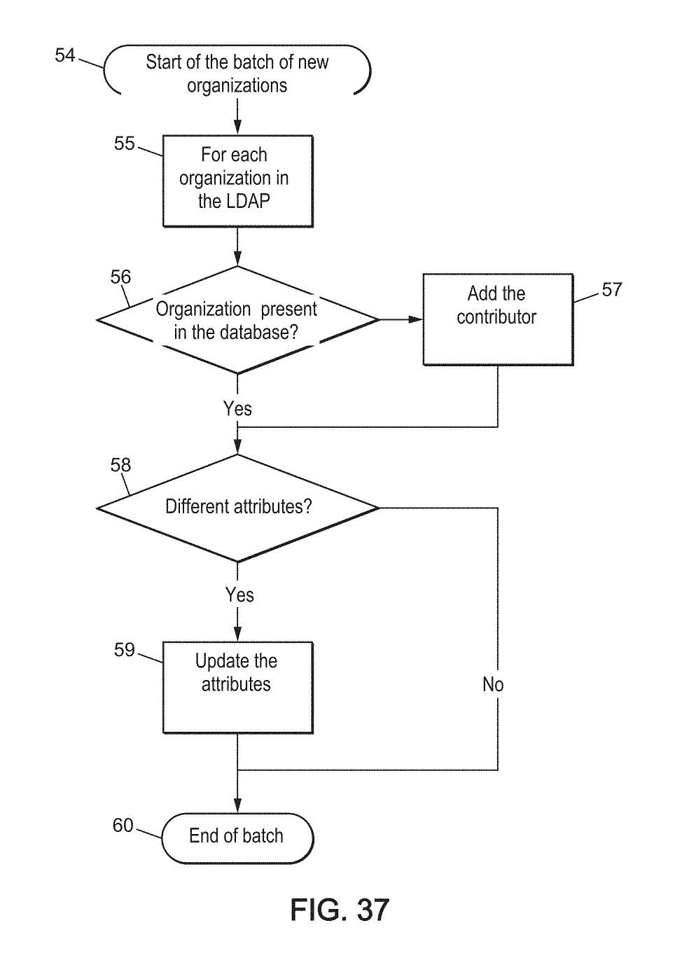

FIG. 37 schematically shows an example of a routine useful for implementation of the method for periodic information collection according to an embodiment of the invention. This routine is used for adding new organizations and updating existing organizations.

The routine starts at functional block 54 with a batch of new organizations. The organizations are taken one by one at block 55. For each organization, their presence in the database is verified in step 56. If they are absent, the organization is added in step 57. In step 58, the attributes of the organization are verified and if needed could be followed by a step 59 of updating the attributes of the organization. The routine ends at the end of batch functional block 60, when this routine has gone through all the organizations in the batch.

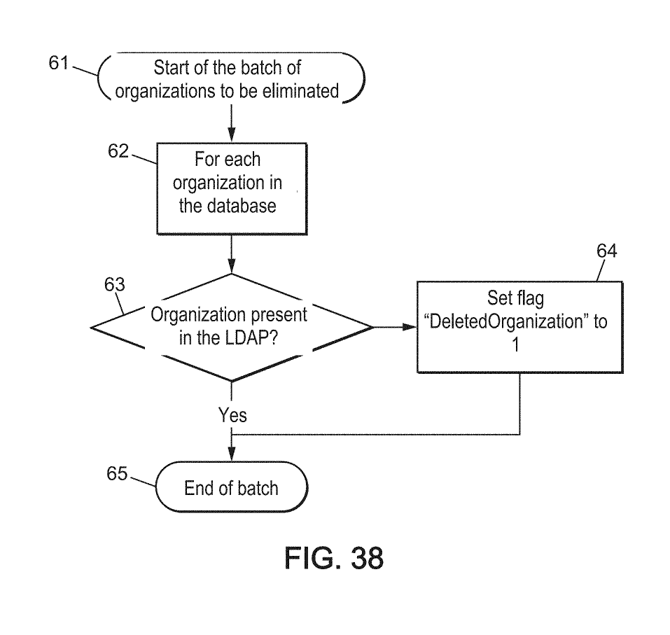

FIG. 38 schematically shows an example of a routine useful for implementation of the method for periodic information collection according to an embodiment of the invention. This routine is used for eliminating obsolete organizations.

The routine starts at functional block 61 with a batch of former organizations to be eliminated because they have left the network. The organizations are taken one by one at block 62. For each organization, their presence in the database is verified in step 63. If they are present, the organization is eliminated in step 64. The routine ends at the end of batch functional block 65, when this routine has gone through all the organizations in the batch.

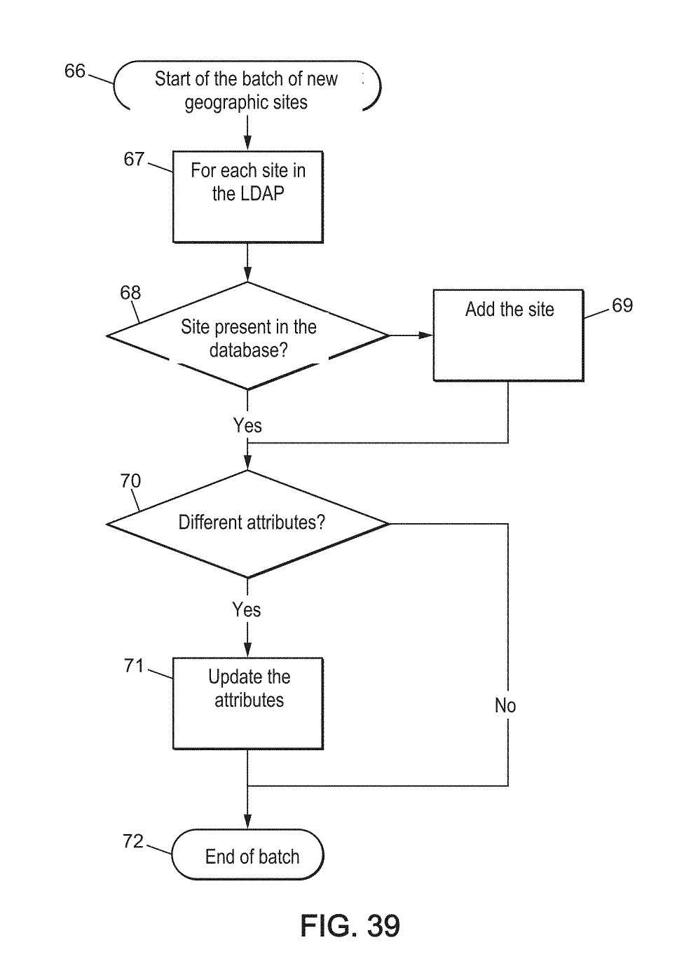

FIG. 39 schematically shows an example of a routine useful for implementation of the method for periodic information collection according to an embodiment of the invention. This routine is used for adding or updating geographic sites.

The routine starts at functional block 66 with a batch of new sites. The sites are taken one by one at block 67. For each site, their presence in the database is verified in step 68. If they are absent, the site is added in step 69. In step 70, the attributes of the site are verified and if needed could be followed by a step 71 of updating the attributes of the site. The routine ends at the end of batch functional block 72, when this routine has gone through all the sites in the batch.

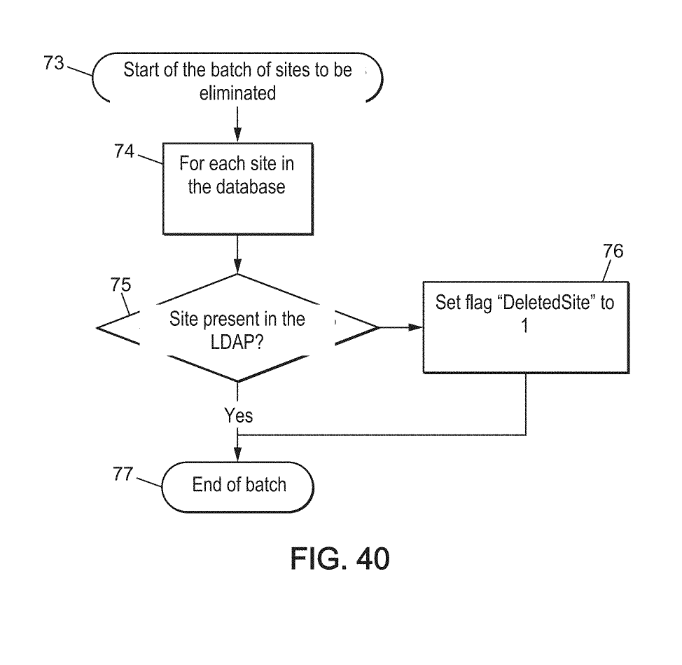

FIG. 40 schematically shows an example of a routine useful for implementation of the method for periodic information collection according to an embodiment of the invention. This routine is used for eliminating geographic sites that are gone.

The routine starts at functional block 73 with a batch of former sites to be eliminated because they have left the network. The sites are taken one by one at block 74. For each site, their presence in the database is verified in step 75. If they are present, the site is eliminated in step 76. The routine ends at the end of batch functional block 77, when this routine has gone through all the sites in the batch.

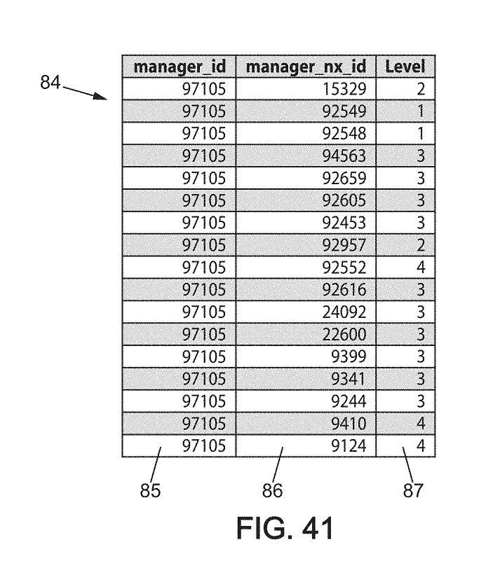

FIG. 41 schematically shows an example of a management tree structure for grouping of users used in a method for periodic information collection according to an embodiment of the invention.

The table 84 contains three columns. A first column 85 contains the identifier of a manager of managers. A second column 86 contains the identifiers of all managers who report to this manager. A third column 87 contains the level X which separates each N-X manager from their N manager of managers.

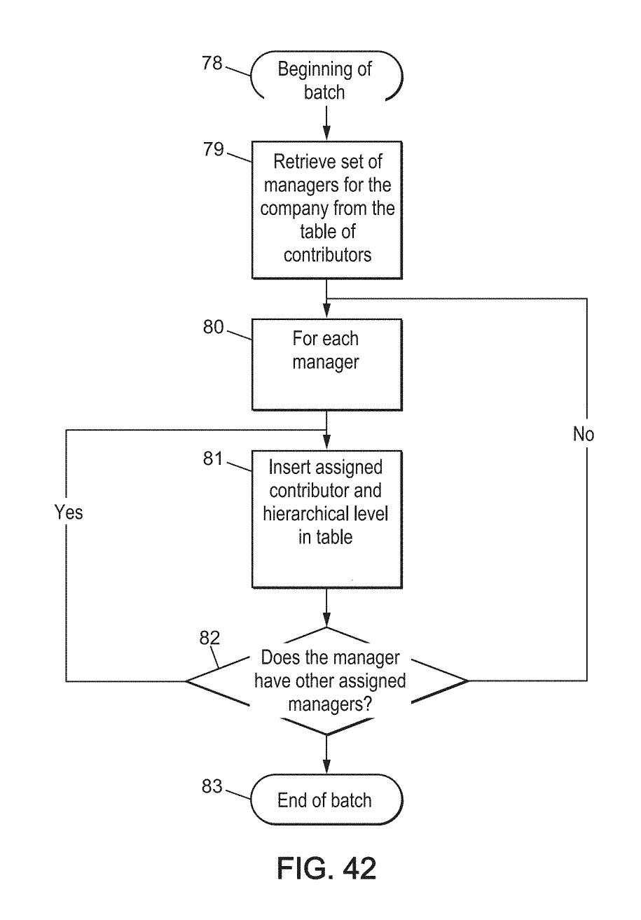

FIG. 42 schematically shows another example of a routine useful for implementation of the method for periodic information collection according to an embodiment of the invention. With this routine, the dynamic table 84 which contains all of the managers assigned to one manager is built up.

The routine starts at functional block 78 which is the beginning of the script. The set of managers is retrieved via the table of contributors at block 79. The managers are taken one by one at block 80. For each manager, in step 81 each manager who is assigned to them is inserted in table 84. If they are absent, the site is added in step 69. A step 82 is done to check for the presence or absence of other managers to be assigned. If there is another manager assigned, insertion step 81 is done again. If all the managers assigned to a given manager were added, the routine resumes with step 80 for the following manager of managers. The routine ends at the end of script functional block 83, when all the managers have been assigned all the managers of managers.

Various calculations are done on the collected information with calculation steps and the results of these processing calculations are then displayed.

To limit the dynamic calculations during the display of a page on the application Internet site, most of the completed calculations are stored in specific tables.

The average score by manager, whether it is the hierarchical or the functional manager, and whether by day, month or year, is stored and kept in memory.

The script retrieves all of the measurements, meaning all of the information collected, for each day, done over 48 hours, meaning at D-1 and D so that time zones can be considered for each manager, and calculates the average over the number of entries, meaning the number of users having sent their reply.

These calculations correspond to:

Day D: Average at D=Sum(Measurement) at D/Number(Measurement) at D

Month M: Average at M=Sum(Measurement) at M/Number(Measurement) at M

Year Y: Average at Y=Sum(Measurement) at Y/Number(Measurement) at Y

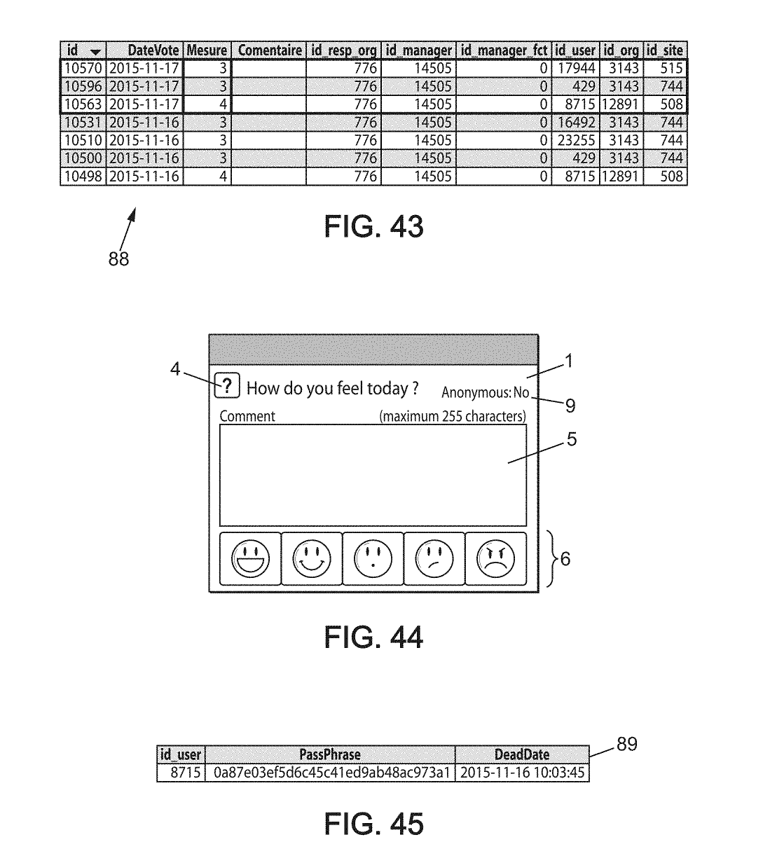

FIG. 43 schematically shows an example of an average calculation done during implementation of the method for periodic information collection according to an embodiment of the invention.

The box in table 88 shows the gathering of data collected for a single day, here Nov. 17, 2015.

To get the average score by manager for manager N-X, by day, month and year, for each manager, the script retrieves the set of associated managers. Then for each associated manager, it retrieves the sum, measurements and number of entries. With this set it is possible to have one Average per manager, including all of the assigned people. Then the set of managers of the relevant manager is then retrieved and also the set of measurements and the number of measurements for the relevant date are retrieved.

These calculations correspond to:

Day D: Average at D for the manager of manager=Sum(Measurement) of the N-X at D/Number(Measurement) of the N-X at D

Month M: Average at M for the manager of manager=Sum(Measurement) of the N-X at M/Number(Measurement) of the N-X at M

Year Y: Average at Y for the manager of manager=Sum(Measurement) of the N-X at Y/Number(Measurement) of the N-X at Y

To get the average score by country, for each day, month and year, each contributor is associated with a geographic site, which is in turn associated with a country. Because of this, it is possible to know the country of assignment of the contributors, which gives us an average by country.

These calculations correspond to:

Day D: Average at D for the country=Sum(Measurement) for the country at D/Number(Measurement) for the country at D

Month M: Average at M for the country=Sum(Measurement) for the country at M/Number(Measurement) for the country at M

Year Y: Average at Y for the country=Sum(Measurement) for the country at Y/Number(Measurement) for the country at Y

To get the global average score for the company, by day, month and year, the entirety of the results for the company are concatenated.

These calculations correspond to:

Day D: Average at D for the company=Sum(Measurement) at D/Number(Measurement) at D

Month M: Average at M for the company=Sum(Measurement) at M/Number(Measurement) at M

Year Y: Average at Y for the company=Sum(Measurement) at Y/Number(Measurement) at Y

FIG. 44 schematically shows another example of automatic display of an interaction window on the station of a user in a method for periodic information collection according to an embodiment of the invention. This automatic display is done on the Windows client (Windows is a registered trademark), meaning on the desktop of the computer station of the user joined in the network.

For logical reasons of security, the Windows client (Windows is a registered trademark) only interacts with the Web Services server, which in the future will allow extending the use of these Web Services to other clients like iOS, Android and Windows Phone, which are registered trademarks.

In order to avoid having contributors enter their identifier and their password daily, a passphrase system between the client and the server was established.

At a regular interval configurable on the system, for example every 20 days, the user is asked to enter their identifier and password. During validation, the server generates a PassPhrase key of 32 characters and digits, and which will subsequently serve for the client to exchange with the server doing away with the identifier as password.

Each time a passphrase is generated, an expiration date is created and after this expiration date the user will again be asked for the identifier and password.

FIG. 45 schematically shows an example of passphrase storage for a user, during implementation of the method for periodic information collection according to an embodiment of the invention. This passphrase is stored in a table 89.

In the settings part, the user has the possibility of choosing the time range during which the application is allowed to display automatically. In order to be able to take the temperature of the user at different daily times, the application displays randomly during this time range. The objective of this mechanism is to avoid retrieving daily the consequences of personal events like transportation problems and to focus on life at work.

If the user has already submitted their entry before the automatic display, the application will not display until the following day.

The corresponding calculation is:

Display time=RANDOM (between start time and end time)

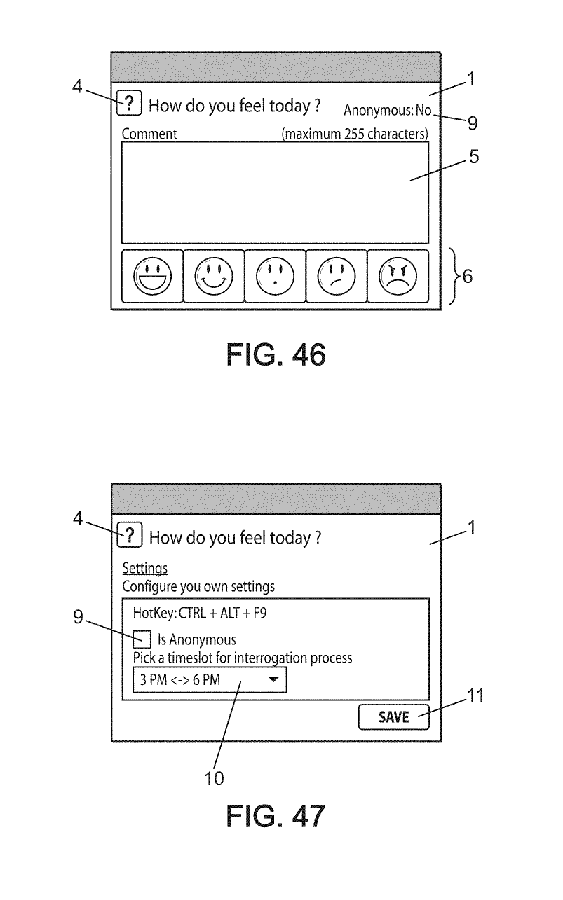

FIG. 46 schematically shows another example of automatic display of an interaction window on the station of a user in a method for periodic information collection according to an embodiment of the invention.

The tab for submitting their entry is only accessible after the moment when, a contributor has not already sent their information via the web interface and also the contributor has not already sent their information via the Windows client (Windows is registered trademark).

In order to limit the calls to the server for the display of this tab, the date of the last vote is retrieved just one time per day and then stored in the register on the user station. Because of this, the application checks the date in the register and does not query the server unless necessary.

When sending information, and to avoid any constraints related to each time zone, the application is based on the date and time of the device used, for example a personal computer, mobile telephone, or tablet. However, to avoid possible deception, the server only considers the transmission if the date and time are consistent with the server's current time.

When sending data, the application must first verify whether the user has already submitted an entry for the relevant day, next verify whether the associated date and time are in agreement with that of the server and finally enter the comment 5, the date, the score 6, the hierarchal and functional manager and then the country of assignment of the user involved. To finish, the interaction window 1 again reduces to the taskbar.

FIG. 47 schematically shows another example of configuration of a user response to an interaction window on the station of a user in a method for periodic information collection according to an embodiment of the invention.

The content of the “Settings” tab is intentionally not backed up in the database in order to not know whether the user has chosen to vote anonymously or not; this anonymizing information 9 remains stored solely on the computer station of the user. It is the same for the time range for querying 10.

Of course, the present invention is not limited to the examples and the embodiment described and shown, but it is subject to many variants accessible to the person skilled in the art.

1-18. (canceled)

19. A method for periodic information collection on a network of computer stations by a computer server on this network, comprising, on the human machine interface (2) of each station of the network, via an application on this station:
an automatic display of an interaction window (1), requesting (4) that the user of this station enter information (5, 6), confirming the response of this user on the user's station and sending it to the server,
where this automatic display is done at least once per collection period, unless there is an early and confirmed response from the user on the user's station or on another computer station which is also associated with this user,
where this response confirmation (11), early or not, leads to:
storage, on the server, of all or part of the information (5, 6) from the response sent;
storage, on the user's station and on the server, of the user response date;
the automatic disappearance of the interaction window (1);
no automatic display of the interaction window (1) during the remainder of the collection period; and
the impossibility of confirming another response from this user, on the user's station or on another computer station which is also associated with this user, during the remainder of the collection period.

20. The method for periodic information collection according to claim 19, wherein the application consults locally, on this station, the response date of the user thereof in order to determine the next automatic display date of the interaction window (1), without querying the server during the remainder of the collection period after confirmation of the response (11).

21. The method for periodic information collection according to claim 19, wherein this automatic display of an interaction window (1) requesting that the user of this station enter information (5, 6) only imposes on the user a single required item of information (6), consisting of a single click by this user, for confirming (11) the response thereof and sending it to the server.

22. The method for periodic information collection according to claim 19, wherein this automatic display is done randomly within a subperiod (10) selected by this user, where this selected subperiod (10) is stored in the user's station.

23. The method for periodic information collection according to claim 22, wherein this subperiod (10) set by this user is stored on the user's station, is not stored on the server.

24. The method for periodic information collection according to claim 19, wherein each user can choose to send the response thereof anonymously or by name where this information (9) about sending anonymously or sending by name is stored on the user's station, is not stored on the server.

25. The method for periodic information collection according to claim 19, wherein during this automatic display of the interaction window (1) asking the user of this station to enter information to confirm (11) the response of this user on the user's station and to send it to the server:
the application also asks the user to enter an identifier (12) and a password (13) for the collection period every N collection periods,
where N is larger than 5,
in case of successful identification and authentication for a collection period, and the application next does not ask the user for either identification (12) or authentication (13) for other collection periods during the remaining time of the N collection periods.

26. The method for periodic information collection according to claim 25, wherein in case of successful identification (12) and authentication (13) for a collection period, then for all the other collection periods during the remaining time of the N collection periods: the application uses a passphrase, which is generated after a successful identification (12) and authentication (13) by the user for one collection period, for direct communication between the user's station and the server without either identification (12) or authentication (13) by the user.

27. The method for periodic information collection according to claim 19, wherein first, before confirming (11) and sending a response proposed by a user, the application verifies whether the user has already verified a response for the current collection period, next, before storing a response sent by the application, the server verifies whether the date of the response sent is consistent with the date of the server, since the response is not accepted by the server otherwise.

28. The method for periodic information collection according to claim 19, wherein:
for information stored on the server, averages are collected by the server:
by user, by grouping of users on one or more levels where the grouping of users to a single given level partitions users of the network of stations, for one or more given times,
by collection period and by multiple collection periods on one or more levels, for one user or for one or more sets of users.

29. The method for periodic information collection according to claim 28, wherein the individual user data (5, 6) are stored on the station of that user and also on the station of the user managing a group of users at the first level including that user, but not on the station of a user managing a group of users at the second level including that user.

30. The method for periodic information collection according to claim 28, wherein:
each user managing a grouping of users at level N, where N is a non-zero integer, can display, on their station or on another computer station which is also associated with that user, averages which were calculated by the server:
by grouping of users at this level N, for one or several given times, and/or
by grouping of users at the level corresponding to the grouping of all users of the network belonging to one country whether that country is the one of the user managing a grouping of users at that level N or another country, for one or more given times, and/or
by grouping of users included in this grouping of users at this level N for one or more given times.

31. The method for periodic information collection according to claim 28, wherein:
each user managing a grouping of users at level N, where N is a non-zero integer, cannot display, on their station or on another computer station which is also associated with that user, averages which were calculated by the server:
by grouping of users at a level strictly above this level N, unless this grouping of users corresponds to the grouping of all users of the network belonging to one country whether that country is the one of the user managing a grouping of users at that level N or another country and/or
by grouping of users included in another grouping of users from this level N.

32. The method for periodic information collection according to claim 28, wherein at least some or all of the averages calculated by the server are permanently stored on the server.

33. The method for periodic information collection according to claim 28, wherein time series for one user or for a group of users are calculated by the server on request.

34. The method for periodic information collection according to claim 19, wherein:
different tables (21 to 41) are used by the server and stored on the server, among them:
a user table (21) containing all the users of the network of stations,
one or more tables (22, 23) of groupings containing all of the groupings, where each table (22, 23) of groupings links (24) to the table of users (21),
a table (27) of response dates,
a table (26) of response information,
possibly a security table (28) containing a passphrase for each user avoiding asking the user to identify and authorize.

35. The method for periodic information collection according to claim 19, wherein the application is accessible by the user on the user's station belonging to the network of stations via the desktop of their station; the application is accessible to the user on another station associated with the user via a web portal.

36. A non-transitory computer-readable medium on which is stored computer code, which when executed by a computer, causes the computer to perform the method for periodic information collection according to claim 19.

37. The method for periodic information collection according to claim 22, wherein this subperiod (10) set by this user is stored on the user's station, is not stored on the server, and is stored only on their station.

38. The method for periodic information collection according to claim 19, wherein each user can choose to send the response thereof anonymously or by name where this information (9) about sending anonymously or sending by name is stored on the user's station, is not stored on the server, and is stored only on the user's station.
